(19) United States
(12) Patent Application Publication
(10) Pub. No.: US 2022/0156275 A1
(43) Pub. Date: May 19, 2022

(54) Data Analytics

(71) Applicant: Joulica Limited, Galway (IE)

(72) Inventors: Sean Burke, Galway (IE); Jonathan Dwyer, Galway (IE); Susannah Gaffney, Galway (IE); Andrew Lavelle, Galway (IE); Diarmuid Leonard, Galway (IE); Anthony McCormack, Galway (IE); John McGreevy, Galway (IE); Joseph Smyth, Galway (IE)

(21) Appl. No.: 17/527,669

(22) Filed: Nov. 16, 2021

(30) Foreign Application Priority Data
Nov. 16, 2020 (GB) 2018017.0

(51) Int. Cl. G06F 16/25

(52) U.S. Cl. CPC G06F 16/254

(57) ABSTRACT

A computer-implemented method and computing system for providing unified data analytics, include receiving data from one or more data sources, and processing the data. One or more statistics are computed by aggregating an output of the processing i) at an instantaneous point in time; and ii) over a predetermined duration of time.

### RELATED APPLICATION

This application claims the benefit of Great Britain Application Serial No. 2018017.0 filed on Nov. 16, 2020. The entire contents of which is incorporated herein by reference.

### FIELD

The present invention relates to data analytics, and in particular but not exclusively to a method and system for providing unified data analytics.

### BACKGROUND

Data analytics has become an important tool in enabling organisations to measure and review performance, for example to ascertain whether critical key performance indicators (KPIs) have been met and to predict and influence future performance. That enables organisations to identify problems and/or potential problems and implement changes to improve or maintain performance.

It can often be useful to conduct real-time data analysis and historical data analysis, performing comparisons between the two to monitor any changes in performance over time. However, conventional approaches utilise separate applications to perform real-time data analysis independently from historical data analysis. Applications which perform real-time data analysis are typically not configured to perform historical data analysis, and vice versa.

The present invention has been devised with the foregoing in mind.

### SUMMARY

According to a first aspect, there is provided a computer-implemented method of providing unified data analytics. The method may comprise receiving data from one or more data sources. The method may also comprise processing the data. The method may additionally comprise computing one or more statistics by aggregating an output of the processing. The method may comprise aggregating an output of the processing at an instantaneous point in time and/or over a predetermined duration of time.

Aggregating an output of the processing at an instantaneous point in time may comprise aggregating an output of the processing over an unbounded interval (e.g., a time interval without a fixed duration). For example, an unbounded interval may span from a fixed initial time to a unspecified later time or a current time. That may enable substantially instantaneous (e.g., substantially real-time) statistics to be computed. Aggregating an output of the processing over a predetermined duration of time may comprise aggregating an output of the processing over a bounded interval (e.g., a time interval having a fixed duration). The bounded interval may have a fixed initial time or a moving initial time. That may enable historical statistics and/or substantially instantaneous (e.g., substantially real-time) statistics to be computed.

Typically, separate applications are used to perform real-time data analytics and historical data analytics respectively. The reason for that is that conventionally, real-time data analytics systems are optimized for speed rather than large volumes of data, whereas historical data analytics systems are optimized for large volumes of data rather than speed. As a result, it is difficult to optimize a single system to perform both real-time and historical data analytics. This means that the manner in which real-time data analytics and historical data analytics are computed (using the respective separate applications) are often significantly different. For example, historical data analytics typically relies upon ad-hoc analysis performed on large volumes of raw data after the raw data has already been placed into storage. That approach is typically incompatible with systems configured to perform real-time data analytics.

The division of real-time data analytics and historical data analytics between separate applications and processes also required a user to consult the separate applications. The user must therefore maintain a mental picture in order to determine whether a statistic computed by a real-time data analytics application corresponds to a statistic computed by a separate historical data analytics application. That increases the difficulty of comparing the two sets of data analytics (real-time and historical) to extract practical insights in order to maintain or improve performance.

By extension, that division also causes difficulties when computing and comparing predictive data analytics with real-time and historical data analytics. In addition, a user is further required to extend their mental model when comparing predictive data analytics to both real-time and historical data analytics.

In contrast, aggregating an output of processing (performed on received data) over different time periods in accordance with the present invention may allow both real-time and historical variants of the same statistic(s) to be computed in a unified manner. Conventionally, as discussed above, real-time and historical data analytics are computed entirely separately, and directly from raw data (which typically requires very different approaches—one optimized for speed, and one optimized for large volumes of data). The present invention may distance the computation of the real-time and historical data analytics from the data itself. Instead, an output of processing or measurements performed on the data may be used as a common basis for computing both the real-time and historical data analytics. The real-time and historical data analytics may be differentiated by aggregating an output of the measurements in different ways such as over different time periods.

The same underlying computational approach or computational logic may therefore be used to compute both the real-time and historical data analytics. That may provide numerous advantages. For example, it may enable a single application to be used and optimized for providing both real-time and historical data analytics, obviating the need for separate applications optimized for substantially different approaches as required conventionally. In particular, it may obviate the need for systems or applications optimized for performing ad-hoc queries on large volumes of stored raw data to provide historical data analytics. It may also provide a more efficient, unified approach for computing real-time and historical data analytics, by providing a common computational framework for both the real-time and historical data analytics. It may also reduce the computing resources required to compute both real-time and historical data analytics.

Providing unified real-time and historical data analytics using the same underlying computational approach may also allow the real-time and historical data analytics to be directly and reliably compared with one another, without requiring a user to manually assess their correspondence (as would be required for real-time and historical data analytics computed using separate applications employing different approaches). That may enable easier extraction of practical insights from the real-time and historical data analytics.

The data may be or comprise event data. The data may be or comprise a stream of event data.

Receiving the data may comprise receiving a stream of substantially real-time events. Processing the data may comprise processing in substantially real-time using one or more events from the stream. That may enable an output of the processing to be aggregated and updated in substantially real-time as events are received. In turn, that may avoid the need for a separate application optimized for determining historical data analytics from large volumes of stored historic data (such applications conventionally not being optimized for speed). Instead, historical data analytics may be computed by aggregating an output of processing performed in substantially real-time. That may allow historical data analytics to be determined quickly and efficiently alongside real-time data analytics. Additionally or alternatively, receiving the data may comprise receiving a stream of events substantially after the events have occurred, for example a stream of pre-stored events. Substantially instantaneous (e.g., not ‘real-time’, but at any point in time relative to the pre-stored stream of events) and historical statistics may be computed for the pre-stored stream of events using the same approach.

The method may comprise defining one or more processing categories. The method may comprise defining, for each of one or more processing categories, a processing logic and one or more events necessary for that processing category. The method may comprise processing the necessary events for each the of one or more processing categories. Rather than providing a separate definition for each individual statistic to be computed, defining one or more processing categories in such a manner may provide an abstraction of or single definition for the logic used to compute a plurality of related statistics. That may simplify the computation of a plurality of related statistics and may enable simple configuration (or reconfiguration) of different or additional statistics using the same processing logic. That may provide a more efficient approach for computing a plurality of real-time and historical statistics from data.

The method may comprise assigning each statistic to a processing category. The method may comprise defining one or more pieces of information from the necessary events for the processing category for processing the events for each statistic. Using the same logic and necessary events defined within a processing category, a large number of different (but related) statistics may be computed by making use of one or more different pieces (or combinations) of information from the necessary events.

The method may comprise temporarily storing one or more events in a cache memory. That may enable one or more events temporarily stored in cache memory to be used in conjunction with one or more subsequent events in order to compute one or more statistics. That may enable processing based on a plurality of events which are temporally distributed (e.g., event that occur and are received at substantially different times) to be performed in substantially real-time. That may avoid the need for post-processing to perform such processing and compute one or more statistics, such as searching large volumes of stored data for related events to compute statistics. That may improve efficiency and reduce computational resources required to compute statistics based on a combination of temporally distributed events. That may also be particularly advantageous for computing statistics based on events having incomplete or missing data.

The method may comprise enriching one or more subsequent events using information from one or more events temporarily stored in the cache memory. That may enable any missing information in one or more subsequent events to be included from the one or more events temporarily stored in the cache memory. The subsequent event(s) may be enriched prior to any processing being performed using the subsequent event(s), which may enable statistics to be computed using the subsequent event(s) in substantially real-time. The method may additionally or alternatively comprise enriching one or more events using information from one or more external sources.

The method may comprise processing one or more events retrieved from the cache memory in combination with one or more subsequent events. The method may additionally or alternatively comprise generating an event sequence using a plurality of related events.

The method may comprise time-stamping the one or more computed statistics. The method may comprise storing the time-stamped statistics computed over a predetermined duration of time. That may enable historical data analytics computed to be easily retrieved and compared to real-time data analytics, if required.

The method may comprise providing the one or more computed statistics to a predictive model. The method may comprise generating one or more predicted statistics based on the one or more computed statistics. That may enable predicted statistics to be unified with the computed statistics, because the computed statistics are directly used to generate the predicted statistics.

The predictive model may be or comprise a machine learning model. The method may comprise providing the one or more statistics computed over a predetermined duration of time to the machine learning model as training data. The method may also comprise providing the one or more statistics computed at an instantaneous point in time to the machine learning model as real data to generate the one or more predicted statistics. The generation of predicted statistics may be simplified using training data and test data both computed using the present invention. The training data and test data may be unified, for example directly comparable to one another, which may enable training and operation of the machine learning model to be streamlined for speed and efficiency.

The method may comprise receiving contextual data associated with one or more events. The method may comprise performing contextual data analysis on the contextual data. The method may also comprise correlating analysed contextual data with one or more computed statistics. The method may comprise performing sentiment and/or intent analysis on speech data and/or text data associated with one or more events.

The predetermined duration of time may comprise a static time window or a moving time window. The predetermined duration of time may enable both real-time data analytics (for example, before expiry of a static time window, or over a moving time window) and historical data analytics (for example, after expiry of a static time window) to be computed.

The method may comprise selecting one or more data output channels from one or more of the data sources. The method may comprise selecting the one or more data output channels based on one or more predefined criteria. That may enable only relevant data channels, for example data channels containing events relevant for computing statistics, to be selected, improving efficiency.

The method may comprise qualifying data from the one or more data sources. The method may comprise qualifying the data based on one or more predefined criteria. That may enable, for example, only events relevant or necessary for computing a statistic to be taken into account. Irrelevant or unnecessary events can be ignored, improving efficiency.

The one or more predefined criteria may comprise the one or more events necessary for each of the one or more processing categories.

The method may comprise mapping or transforming data from one or more data sources to a common data format. That may place the data from one or more data sources in a form suitable for computing statistics. That may also enable data from disparate or incompatible sources to be processed and/or correlated using a consistent approach.

According to a second aspect, there is provided a system for providing unified data analytics. The system may be configured to perform the method of the first aspect. The system may comprise a module configured to receive data from one or more data sources. The system may also comprise a module configured to process the data. The system may comprise a module configured to aggregate an output of the processing. The module may be configured to compute one or more statistics by aggregating an output of the processing at an instantaneous point in time and/or over a predetermined duration of time.

The system may be configured to perform one or more of the method steps described above, and one or more additional modules may be provided for performing a single step or multiple steps in any suitable combination. Such modules are specifically envisaged.

Features which are described in the context of separate aspects and embodiments of the invention may be used together and/or be interchangeable wherever possible. Similarly, where features are described in the context of a single embodiment for brevity, those features may also be provided separately or in any suitable sub-combination. Features described in connection with the method of the first aspect may have corresponding features definable with respect to the system of the second aspect, and vice versa, and these embodiments are specifically envisaged.

### BRIEF DESCRIPTION OF DRAWINGS

The invention will now be described by way of example only with reference to the accompanying drawings in which:

FIG. 1 shows a method of performing data analytics in accordance with an embodiment of the invention; and

FIG. 2 shows the computing step of the method shown in FIG. 1 in more detail;

FIG. 3 shows another method of performing data analytics comprising caching one or more events in accordance an embodiment of the invention;

FIG. 4 shows another method of performing data analytics comprising performing predictive analytics in accordance with an embodiment of the invention;

FIG. 5 shows another method of performing data analytics comprising performing contextual data analytics in accordance with an embodiment of the invention; and

FIG. 6 shows a system for performing unified data analytics in accordance with an embodiment of the invention;

FIG. 7 shows another system for performing unified data analytics for a contact center in accordance with an embodiment of the invention; and

FIG. 8 shows another system for performing unified data analytics for vehicle fleets in accordance with an embodiment of the invention.

Like reference numerals and designations in the various drawings may indicate like elements.

### DETAILED DESCRIPTION

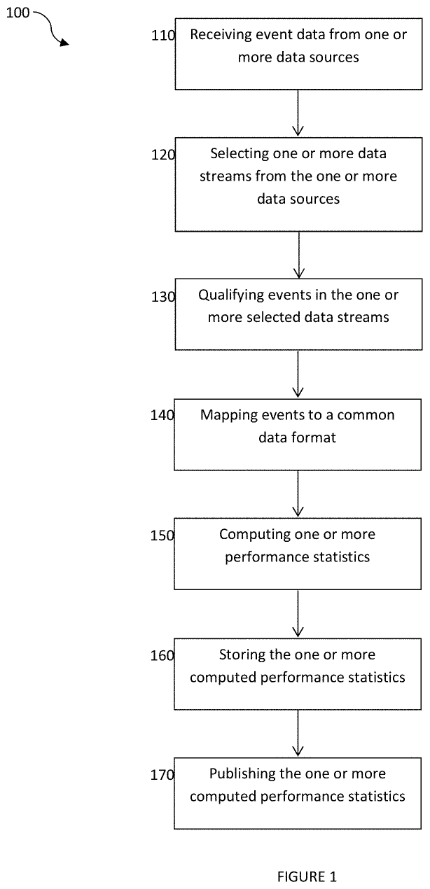

FIG. 1 shows an embodiment of a method 100 for performing data analytics. In the embodiment shown, the method 100 relates to event-driven or streaming analytics. In the embodiment shown, the method 100 relates to performing real-time data analysis and historical data analysis on contact centre data. However, it will be appreciated that the method 100 is equally applicable to performing data analytics on any data set, for example any data set comprising event data. An example of such data is vehicle fleet data such as bus fleet data or taxi fleet data.

Step 110 of the method 100 comprises obtaining or receiving event data from one or more data sources. The event data may be or comprise a stream of event data, for example a stream of substantially live (e.g., real-time) event data. Data sources for a contact centre may be or comprise software data sources or hardware data sources. For example, a vendor that delivers phone calls to the contact centre may act as a data source. A single contact centre may employ a plurality of vendors to deliver phone calls to the contact centre, with each vendor acting as a separate data source. An instant messaging application for communicating with customers may act as another data source. The exact nature of the data source(s) is not important. Any data source generating event data which could be analysed to assess performance of the contact centre may be used. The data sources generate event data indicative of one or more events that are occurring or have occurred during operation of the contact centre (for example, receiving, transferring or ending a call).

In the contact center domain, customer interactions may be received from a wide variety of data sources (e.g., different media). Examples of data sources or media through which customer interactions may be received include (but are not limited to) telephony, email, web chat, mobile chat, SMS, WhatsApp®, social media, video, chat bots and virtual media. Non-digital interaction sources are also possible, including but not limited to retail store interactions, bank branch visits, car dealer visits etc.

Step 120 of the method 100 comprises selecting one or more data streams or output data channels from the one or more data sources. One or more of the data sources may comprise one or more data streams. A data stream may comprise a property of a messaging technology to deliver events (for example in the case of Kafka it may comprise a topic) or the data stream may comprise a subset of the events, e.g. all events of a specific type or types.

For example, an application on a desktop may generate multiple output data channels (for example, a data stream per window such as different chat windows with different customers within a web chat application, a mouse click data stream etc.) Selecting one or more data streams to be analysed from each of the one or more data sources may allow focus to be placed on data streams which contain event data that is of interest and/or necessary for assessing performance of the contact centre, according to one or more predefined criteria. In some embodiments, the one or more predefined criteria are or comprise one or more analytical or performance statistics to be determined for the contact centre. Pre-defining one or more analytical or performance statistics to be determined may enable only data streams that contain events relevant for determining those analytical or performance statistics are selected. In some embodiments, the method 100 may not comprise step 120. For example, all data streams from the one or more data sources may contain relevant event data. Alternatively, the one or more data sources may each comprise only one data stream.

Step 130 of the method 100 comprises qualifying events in the one or more (optionally selected) data streams. Qualifying events in the data stream(s) may comprise identifying events in the data stream(s) which are of interest and/or necessary for assessing performance of the contact centre, according to one or more predefined criteria. In some embodiments, the one or more predefined criteria are or comprise one or more performance statistics to be determined for the contact centre. By pre-defining one or more performance statistics to be determined, only events relevant for determining those performance statistics may be qualified, reducing the volume of data made available for assessing performance. Not all events in a data stream may be relevant, of interest or necessary for assessing performance of the contact centre. For example, if a contact center agent is communicating with a customer over web chat, events relating to the agent maximizing or minimizing the chat window may not be qualified as they are not of primary interest when measuring the performance of the agent. In some embodiments, the method 100 may not comprise step 130. If the one or more data streams are specific enough (for example, the data stream(s) only contain(s) events which are relevant and/or necessary for assessing performance of the contact centre), then qualification may not be necessary.

Step 140 of the method 100 comprises mapping or transforming the (optionally qualified) events obtained or received from the one or more data sources (or optionally one or more selected data streams) to a common data format or data structure. In some embodiments, events from different data sources or different data streams may not be in the same data format. In that case, it may not be possible to process or correlate events or event information from different data sources or different data streams until or unless the event data is placed in a common data format. Step 140 of the method 100 effectively comprises pre-processing the qualified raw event data to place it in a form suitable for analysis by the method 100. Step 140 enables event data taken from any data source to be analysed using the method 100. The exact transformation of the raw data to the common data format is configurable dependent upon the format of the raw data. In some embodiments, the method 100 may not comprise step 140. For example, if relevant event data from different data sources or different data streams is already in a single data format, or relevant event data is taken from a single data source or data stream, mapping the event data to a common format may not be necessary.

Step 140 can optionally include automated mapping of events from multiple data streams to the common data format. This automated mapping can also optionally include an Al based approach comprising automatically mapping fields which are commonly mapped together. For example, in the case of a contact center, step 140 may comprise automatically mapping events containing the field agentId and other events containing the field UserId to a common format in which AgentId is used to hold the value of the fields agentId and UserId respectively. The automated mapping option can include a user accepting the automated mapping, and alternatively may comprise the automated mapping being implemented without the intervention of a user.

Step 150 of the method 100 comprises computing one or more performance statistics for the event data.

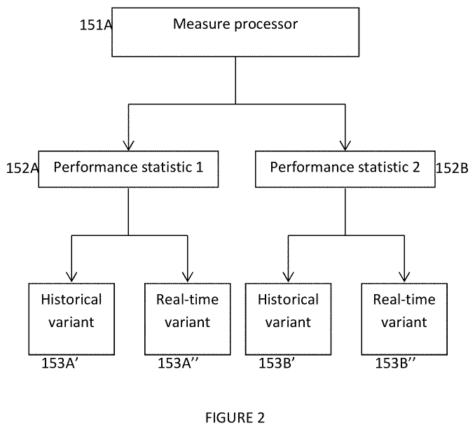

FIG. 2 shows step 150 of the method 100 in more detail. In the embodiment shown, one or more performance statistics 152A, 152B are computed using a measure processor 151. In the present disclosure, a measure processor is or comprises an algorithm defining how a class or type of performance statistic is to be computed. The measure processor 151 contains logic defining how the type of performance statistic is to be computed (e.g., how the event(s) or event data is to be processed). Each measure processor used in the method 100 may therefore utilise one or more predefined criteria which can be used to select relevant data streams and qualify relevant events within those data streams, as described above. That may enable only events which are necessary for computing performance statistics 152A, 152B of interest to be identified and extracted from the whole set of event data before computation of the performance statistics 152A, 152B. A user may therefore specify which performance statistics are of interest, and which events are necessary for computing those performance statistics, and the method 100 automatically handles selecting data streams and qualifying events.

A single measure processor 151 may enable a large number of different (but related) performance statistics to be computed. A measure processor 151 may specify or define how one or more events are to be processed. For example, the algorithmic logic of a single measure processor may be implemented on the same event (or combination of events) using different time window types, dimensions and attribution types, either alone or in combination with one another. The time window types, dimensions and attribution types are configurable by a user. Rather than providing a specific definition for each individual performance statistic 152A, 152B, a measure processor 151 effectively abstracts (e.g., provides a single definition for) the logic used to compute a large number of related performance statistics. Only the pieces of information from the events (either singular pieces or combinations) required for each performance statistics are separately defined for each of the performance statistics. That may simplify the computation of many related performance statistics and may enable the method to be easily configurable (or reconfigurable) to compute different and/or additional performance statistics using that same measure processor. The measure processors may be considered as categories or types of processing or measurements defined by a processing or measurement logic and the events necessary to perform the processing or measurements, whilst performance statistics may be thought of as sub-categories or sub-types of that processing or measurement, defined by one or more pieces of data taken from the necessary events.

In the present disclosure, a dimension is or comprises a category derived directly or indirectly from event data or information. An example of a dimension is Agent, where an example instance of the Agent dimension is Agent “Joe Smith”. Another example of a dimension is Customer Location where an example instance of the Customer Location dimension is London. For example, in a contact centre, a performance statistic of interest may be a length of time a particular agent was on a call. The necessary information for computing that performance statistic is an agent ID, a call start time and a call end time. The dimension of the performance statistic in this example is Agent, with agent ID representing the instance of the dimension for that performance statistic. Alternatively, another performance statistic of interest may be a length of time of a call (without specifying a particular agent). That could be used to represent the cumulative amount of time all agents have spent conversing with customers. The necessary information for computing that performance statistic is a call start time and a call end time. In that example, the dimension could be System with only one instance—Contact Center. However, the processing logic (and necessary events—a call starting, and a call ending) for computing both performance statistics is identical. By providing a single definition for how to perform the calculation, the individual performance statistics can be computed more simply by separately defining the input event information required for each performance statistic. Other examples of categories of data which can be included as a dimension are a queue type (e.g., a queue for sales calls, a queue for support calls).

Returning to FIG. 2, different performance statistics 152A, 152B within a measure processor 151 may be characterized by the number and/or type of dimensions used to compute the performance statistic.

The method 100 may comprise computing one or more performance statistics using different time window types. The method 100 may comprise processing events or event data (e.g., performing one or more measurements) in substantially real-time as events are received using the logic contained in the measure processor. The output of the processing is then aggregated using different time window types, which may allow the same performance statistic to be computed in time in different ways. In the embodiment shown, time window types include but are not limited to interval windows and instantaneous windows.

An interval window is a predetermined duration of time over or during which performance statistics are computed. The predetermined duration of time is a bounded interval. The predetermined duration of time is configurable and may be or comprise any suitable length of time, for example, 5 minutes, 15 minutes, 30 minutes, 1 hour, 2 hours, 8 hours, 24 hours etc. The output of the real-time processing or measurements within a measure processor may be aggregated over the time window. For example, the number of occurrences of a given event (e.g., a number of calls received by the contact centre) may be totaled over the time window. The individual occurrences of the event (e.g., receiving a call) are processed or measured substantially in real-time as events are received, as discussed above. The predetermined duration of time may be a static time window or a moving time window. The performance statistic may be based on events received in each time window, such that only events occurring in the time window of interest contribute to the value of the performance statistic for that time window. The performance statistic is computed separately for each consecutive time window, with the aggregated output of the processing or measurements being reset at the start of each new time window. A static window time window may correspond to a fixed period of time, for example, each consecutive period of 15 minutes since a start time, or a period of 15 minutes at the start of each hour. If a moving time window is used, the performance statistic may be based on events received in the predetermined length of time before a current time (e.g., the preceding 5 minutes, 15 minutes, 30 minutes, 1 hour etc.) The performance statistic may be updated continuously to exclude an output of processing or measurements based on events received longer ago than the predetermined length of time before the current time.

An instantaneous window is not bounded by an interval (e.g., from an initial fixed time to a current time). Rather, an instantaneous window is used to compute a performance statistic at an instantaneous point in time. An example may be the total number of agents currently logged in at the contact centre. In an example not related to a contact center, an instantaneous performance statistic could be used to represent the number of cars currently in a car park. The individual occurrences are processed or measured substantially in real-time as events are received. An agent logging in may increment a counter, whilst an agent logging out may decrement a counter. An instantaneous evaluation of that performance measure (e.g., counter) indicates the number of agents logged in at that specific moment in time. A counter may operate continuously without being reset, resulting in the counter providing a real-time value for the total number of agents currently logged in. Another example may be the total number of calls received to date. Using an instantaneous window (e.g., without a bounded interval), a counter monitoring number of calls received will continue to count indefinitely and in turn will reflect the total number of calls since counting began. That is in contrast to using an interval window for monitoring a number of calls, which will result in the counter being reset on expiry of the predetermined duration of time (either resetting to 0 for a static window, or being decremented for a moving window). In some embodiments, an instantaneous window can be thought of as providing an aggregated output of the real-time processing or measurements over an interval to date (e.g., without any reset).

In the embodiment shown, the method 100 comprises computing and/or evaluating the same single performance statistic over both at least one interval window and an instantaneous window within a single measure processor. The embodiment shown illustrates that multiple windows (e.g., a 15 minute window, a 30 minute window and a moving window) may be employed for a single performance statistic. Evaluating the same performance statistic 152A, 1528 over different time windows may allow both instantaneous, real-time data analysis and historical data analysis to be performed using a single application. The interval window and the instantaneous window respectively provide a historical variant 153A′, 153B′ and a real-time variant 153A″, 153B″ of the same performance statistic 152A, 1528.

In an embodiment, the method 100 comprises time-stamping a performance statistic computed using an interval window and placing the time-stamped performance statistic into storage (see step 160 below). That results in historical performance statistics being computed and stored directly (e.g., as frequently as the performance statistic is updated or when an interval window expires), rather than storing raw event data and later performing analysis to compute historical performance statistics. That in turn allows a real-time performance statistic computed using an instantaneous window to be easily and directly compared to the same performance statistic computed using an interval window at any period or point in time previously.

It will also be appreciated that an interval window may be used to compute real-time performance statistics as well as historical performance statistics. For example, a performance statistic may be or comprise call time for an agent. The performance statistic may be computed using an interval window having a predetermined duration of, for example, 2 hours. The agent call time within the interval window may be updated in substantially real-time (and optionally published to a dashboard or display) as soon as events (e.g., call received, call ended) occur, as discussed above. As a result, before the interval window expires, the call time computed for that time period is an aggregate of the measurements computed from the start of the interval window to a current time, and effectively represents an up-to-date, real-time performance statistic for events occurring within that interval window. Once the interval window expires (and the aggregated output of the measurements resets), the call time aggregated over the whole time period of the interval window represents a historical performance statistic for the interval window.

By storing time-stamped performance statistics computed using an interval window, a previously computed performance statistic can be easily and quickly retrieved and directly compared to the same real-time performance statistic computed using an instantaneous window and/or one or more interval windows. In that way, real-time data analysis and historical data analysis is unified. The analysis is unified from the perspective that the real-time performance statistics and historical performance statistics are directly comparable to one another because the two sets of computed statistics have been computed as part of the same process (e.g., using a single approach which may be implemented within a single application or program).The method 100 may therefore provide a direct linkage between the real-time and historical analytics. One example where that may be useful is to enable a user of an analytics visualization system to easily navigate between the real-time and historical analysis. That means a user does not need to manually assess whether the historical statistics actually correspond to the real-time statistics. The correspondence is guaranteed by virtue of how the real-time and historical performance statistics are computed in the method 100. That may enable improved (e.g., faster and/or easier) extraction of practical insight from the data analytics by a user.

That is in direct contrast to the conventional approach of performing historical data analysis separately from real-time data analytics, using an entirely different process and/or application. That is typically achieved by performing ad-hoc queries on large volumes of raw data stored in a database. Such conventional approaches mean that before the historical data analytics can be utilized, a user has to manually assess whether the historical data analytics are relevant and/or directly comparable to the real-time data analytics. That must be done in order to avoid drawing meaningless conclusions from the comparison (e.g., to ensure a real-time performance statistic is actually being compared to a relevant, corresponding historical performance statistic), since the real-time data analytics are typically computed in a substantially different manner to the historical data analytics and/or there is not a unified approach which links the real-time and historical analytics together.

The method 100 described above may avoid the need to use a separate application to compute historical performance statistics by performing ad-hoc queries on large volumes of raw data stored in a database or data warehouse. The method 100 may enable historical data analysis to be carried out in conjunction with real-time analysis using a single application. The processing approach used in the method 100 is substantially similar for both real-time and historical performance statistics, differentiated by the time window over which the performance statistics are computed. The similarity of the processing for both real-time and historical performance statistics means that a single system, program or application may be capable of computing both real-time and historical data analytics. In addition, that may enable both types of data analytics to be stored in a single location for simple retrieval by a user.

In the present disclosure, an attribution type may be used to determine whether or not an event should be taken into consideration for computing a performance statistic at a given time or in a given period of time. For example, an attribution type may be Start of Session. In that case, a performance statistic such as a duration (e.g., length of time of a call) will be considered as falling within a given interval window if it starts in that interval window. That may enable, for example, the number of calls exceeding a threshold duration (e.g., 5 minutes, 10 minutes, 30 minutes) and starting within a given interval window to be counted. Another attribution type may be End of Session. In that case, a performance statistic such as a duration will be considered as falling within a given interval window if it ends in that interval window. Attribution types typically deal with scenarios in which the events for a performance statistic occur over multiple time windows or intervals, for example event 1 occurs in first interval and event 2 occurs in a subsequent (e.g., second) interval. The attribution type specifies how the performance statistic should be calculated. For example, the attribution type may determine, for example, whether event 2 should be processed in the context of the first interval, or the subsequent (e.g., second) Interval 2, or alternatively in both intervals using some form of apportioning. Another example of an attribution type is On Action. In that case, a performance statistic such as a count or duration will be considered as falling within a given interval window if an event that triggers the computation occurs within that window. A further example of an attribution type is On Interval. In that case, a count or a portion of a duration that finishes within a given interval window will be considered as falling within (e.g., associated with) that window.

Examples of different algorithm types which can be used in separate measure processors of the present disclosure include but are not limited to Count algorithms, Count Once algorithms, Modify by Value algorithms, Duration algorithms, Counter algorithms, Logical algorithms, and Multiplicity algorithms.

A Count algorithm may increment a count based on one or many events. An example of a count which is incremented based on one event is a single event being used to signal the arrival of a new call into the system. That single event may be used independently or irrespective of how the call arrives. Therefore, to count incoming calls, it is sufficient to maintain a counter based on that event. An example of where many events may be needed to increment a count is a call being disconnected. A different event may be used depending on whether the customer or agent disconnects. The count may be incremented based on the occurrence of a single event (for example, number of calls answered) or based on the occurrence of a plurality of related events (for example, start time and end time of a call to compute a number of calls exceeding a threshold duration). To increment a count based on a plurality of related events, a correlation identifier may be required to associate the related events with one another. The correlation identifier may be or comprise any piece of information which is common to two or more events in a plurality of related events, for example a call ID, an agent ID, a customer ID etc. The increment may be time-stamped to allow the increment or decrement to be allocated to a given interval of time (e.g., an interval window) for historical data analysis purposes. A Count algorithm may also be used, for example, to compute a number of calls that are currently waiting on a queue.

A Count Once algorithm may also increment or decrement a count based on one or many events. To increment or decrement based on a plurality of related events, a correlation identifier may be required, as described above. However, a Count Once algorithm will only increment or decrement once per occurrence of a correlation identifier. For example, a Count Once algorithm may be used to monitor a number of calls that are placed on hold at least once. If a calling party (e.g., a customer) is put in hold twice, the Count Once algorithm will only increment a count once.

A Modify by Value algorithm may increment or decrement a counter based on a value associated with an event, rather than based on the occurrence of the event itself. The counter can be incremented or decremented by any value. The counter is not limited to be incremented by a value of 1 or decremented by a value of 1. For example, a Modify by Value algorithm may be used to increment a number of messages sent and/or received in a chat session. An event may be received containing information relating to the number of messages sent and/or received in a time period, for example in the last second.

A Duration algorithm may compute the time between events, for example in milliseconds, seconds, minutes etc. A correlation identifier may be required to associate the events, for example, a call ID may be used to associate a start time of a call and a transfer time or end time of a call. For example, a Duration algorithm may be used to compute a total length of time that all calls were waiting for an agent in a queue over a given time period.

A Counter algorithm may increment or decrement a counter based on one or many events. A correlation identifier may be required to associate events with one another. For example, the number of agents currently logged in may be computed using a Counter algorithm, with the counter being incremented in response to an agent logging in and decremented in response to an agent logging out. In other examples, a Counter algorithm may be used to compute a number of calls that are currently waiting on a queue, and/or to compute a number of calls that arrive on a queue for a given time period.

A Logical algorithm may be used, for example, to calculate a duration across multiple users or agents in the same state. In this context, ‘logical’ means the state of a given parameter from multiple inputs. For example, a Logical algorithm may be used to compute the combined time that all agents are logged in over a given time period. A Logical algorithm may also be used, for example, to compute a total time that all agents assigned to a queue are busy with contacts, or an amount of time that no agents are logged into a queue.

A Multiplicity algorithm may be used, for example, when an agent is occupied by more than one customer simultaneously. For example, an agent may be in communication with two customers over an instant messaging chat or SMS simultaneously.

A Multiplicity algorithm may count an overlapping duration. For example, when communication ends between one agent and two contacts or customers in different time intervals, the Multiplicity algorithm ensures that the agent's time is aggregated across both interactions. That means that the time is an aggregate and not a combination of the time spent engaging with the different customers. A Multiplicity algorithm may also be used, for example, to compute a total length of time that an agent is active on multiple concurrent calls over a given time period.

A Multiplicity algorithm may also be used to count an aggregated state and availability of an agent. For example, an agent may begin work with a first contact or customer and then subsequently begin work with a second contact or customer. The agent may then complete or finish work with the first contact, and then subsequently complete work with the second contact. A Multiplicity algorithm may compute the time between the start of work with the first contact and the end of work with the second contact. Together with the durations, a Multiplicity algorithm may also aggregate a state of the agent. Examples of agent states could be Idle (processing 0 contacts), Busy and Available (processing 1 contact), and Busy (processing 3 of 3 contacts).

In some embodiments, the method 100 allows new measure processors to be specified by an end user of the system, allowing the functionality to be extended whilst also utilising the existing capabilities provided by the method 100. For example, a user could implement a new measure processor whereby the current value of a performance statistic is “squared” each time an event is received. The user could specify the behaviour of the new measure processor via an extension. An example of an extension may be a custom processor implemented by a user, wherein the customer processor may be made available as an API. The method 100 may comprise invoking the API.

In some embodiments, the method 100 may further comprise generating an alert in response to a computed performance statistic not meeting a predetermined threshold. For example, a computed performance statistic may exceed a predetermined threshold (e.g., number of calls exceeding a predetermined duration) or falls below a predetermined threshold. The predetermined threshold may be configurable or reconfigurable by a user or external application via an API invocation. The method 100 may further comprise publishing or displaying the generated alert together with the computed performance statistics (see step 170).

Returning to FIG. 1, step 160 of the method 100 comprises storing the one or more computed performance statistics. In the embodiment shown, the method 100 comprises storing the one or more performance statistics computed using an interval window in a storage system for easy retrieval. Examples of storage systems are NOSQL and SQL database systems, in-memory caches, distributed caches, time series storage systems.

Step 170 of the method 100 comprises publishing the one or more computed performance statistics. In the embodiment shown, the method 100 comprises publishing one or more real-time performance statistics computed using one or more interval windows and instantaneous windows, and/or one or more historical performance statistics computed using an interval window. The method 100 may comprise publishing the one or more computed performance statistics to a display or dashboard of the application used to compute the performance statistics for visualization of the computed performance statistics. Alternatively or additionally, the method 100 may comprise publishing the one or more computed performance statistics to one or more other applications for integration with external systems and visualization of the computed performance statistics.

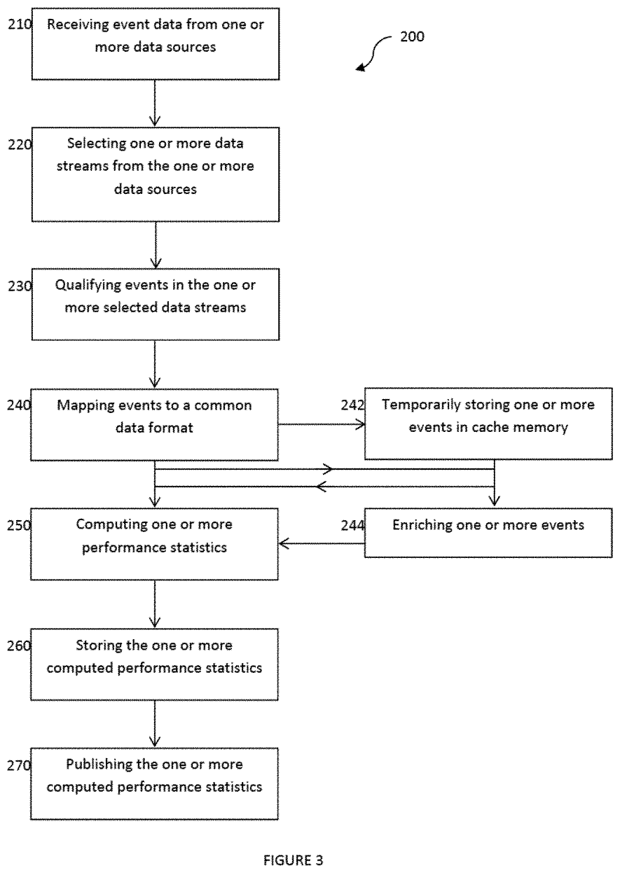

FIG. 3 shows another embodiment of a method 200 for performing data analytics on a data set. The method 200 comprises similar steps to the method 100 described above, with corresponding steps indicated by like reference numerals.

Step 242 of the method 200 comprises caching one or more events and/or a subset of information from each of one or more events (e.g., temporarily storing at least a subset of information from each of one or more of the events in cache memory). References in the following passages to caching one or more events include references to caching at least a subset of information from each of one or more events. Caching one or more events may enable substantially real-time processing or measurements to be performed based on a plurality of related events. The predefined criteria set by the measure processors and/or performance statistics within each measure processor mean that the events that must be related to one another in order to perform the substantially real-time processing or measurements are already known. The method 200 is inherently configured to handle ‘dirty’ events (e.g., events having incomplete or missing data) in real-time, as described below.

For example, when a first event of a plurality of related events is received, the first event is temporarily stored in cache memory. The measure processors and performance statistics are predefined. That means it is already known that information from the first event will be needed in combination with information from one or more subsequent events in order to perform substantially real-time processing (and subsequently compute a performance statistic). The first event is therefore temporarily stored in cache memory to be used in conjunction with one or more subsequent events. However, it will be appreciated that in parallel with that, a performance statistic may also be computed based on the occurrence of the first event alone.

When one or more later (e.g., second, third, etc.) events of the plurality of related events are received, the first event may be retrieved from the cache memory and processing or a measurement performed using information each of the first event and the one or more later events. The first event is correlated to the one or more later events using a correlation identifier. As described above, the correlation identifier may be or comprise any piece of information which is common to two or more events in a plurality of related events, for example a call ID, an agent ID, a customer ID etc. The first event may be stored in cache memory until all processing or measurements that require information from the first event have been performed. After that point, the first event may serve no further purpose, and may be deleted from the cache memory. It will be appreciated that later (e.g., second, third) events in a plurality of related events may also be temporarily stored in cache memory, if necessary for performing processing or measurements in computing a performance statistic.

An example of caching one or more events may be seen in measuring a length of time of a call. A first event may be receiving a call. The first event may contain three pieces of information, for example a call ID, a calling party (party making the call), and a called party (party receiving the call). When the first event is received, it is temporarily stored in the cache memory. A second event may be ending the call. The second event may contain two pieces of information, for example a call ID and a called party. The first event and the second event may be correlated using the call ID, and the times of the first event and second event respectively used to measure a call duration. In the above example, if the performance statistic of interest is a measure of time spent on calls by the calling party, the calling party information or identifier must be retrieved from the cache to update the performance statistic (since the calling party identifier is not present in the second event).

Caching one or more events may allow the computation of performance statistics by performing processing or measurements in substantially real-time using event data that is ‘dirty’ (e.g., events having incomplete or missing data). Ordinarily, processing of such event data to compute performance statistics would have to be computed after the fact, once the first and second events are stored in a database or data warehouse. With such conventional methods and systems, a user has to write specific code for computing those performance statistics. Using the method 100, a user can simply configure (rather than code) that approach by specifying which performance statistics are of interest and the necessary events, and the method 100 handles the management and processing of ‘dirty’ event data using caching to compute the performance statistics.

The length of time that events may be temporarily stored in cache memory is configurable and depends upon the specific event. For example, a contact centre may be contacted by telephone, by instant messaging application, or by email. Although telephone and instant messaging are more instantaneous than email, the event structures or event sequences are substantially the same for each mode of communication. One or more events relating to email communication may be temporarily stored in cache memory for longer than an equivalent event for telephone or instant messaging communication.

Step 244 of the method 200 comprises enriching one or more events. In some embodiments, step 244 comprises enriching one or more events with information taken from one or more previous events temporarily stored in cache memory. In such embodiments, step 244 (enrichment) takes place after step 240 (mapping) and step 242 (caching), but before step 250 (computing).

For example, a telephone call to an agent in a contact centre may comprise the following events:
1) Event 1 ‘Ringing’—event 1 contains a call ID, an agent ID, a queue ID and a customer ID.
2) Event 2 ‘Answered’—event 2 contains the call ID and the agent ID.
3) Event 3 ‘Transfer’—event 3 contains the call ID, a new agent ID and a new queue ID.
4) Event 4 ‘Ended’—event 4 contains the call ID.

In the example above, event 1 is cached. When event 2 is subsequently arrives, event 2 may be correlated with event 1 using the call ID. In addition, event 2 may be enriched by including both the queue ID and the customer ID from event 1. Event 2 is enriched using information from event 1 before any processing or measurements is/are performed using event 2. That allows any missing information to be included so that the processing or measurements requiring event 2 can be computed substantially immediately (e.g., in substantially real-time). The same applies to events 3 and 4, to which missing data can be added. However, data that has been updated between subsequent events may not be used to enrich the subsequent events. For example, event 3 will not be enriched to include the original agent ID from event 1 or event 2, because a new agent ID has been assigned by virtue of the call transfer. Event 4 may be enriched to include the updated agent ID, updated queue ID and customer ID.

Following enrichment, the events sent to be analysed by the measure processors would be as follows:
1) Event 1 ‘Ringing’—event 1 contains a call ID, an agent ID, a queue ID and a customer ID.
2) Event 2 ‘Answered’—event 2 contains the call ID and agent ID. Event 2 is enriched to include the queue ID and customer ID from event 1.
3) Event 3 ‘Transfer’—event 3 contains the call ID, a new agent ID and a new queue ID. Event 3 is enriched to include the customer ID from event 1, but the updated agent ID and updated queue ID are retained.
4) Event 4 ‘Ended’—event 4 contains the call ID. Event 4 is enriched to include the customer ID from event 1, and the updated agent ID and updated queue ID from event 3. After enrichment, event 4 comprises four pieces of information rather than the original one piece of information.

Enrichment may also update an event with previous values of an updated piece of information. For example, with respect to events 3 and 4 in the example above:
3) Event 3 ‘Transfer’—event 3 contains the call ID, a new agent ID and a new queue ID. Event 3 may be enriched by including the customer ID from event 1. The updated agent ID and updated queue ID are retained. However, the original agent ID from event 1 and event 2 may be included as a new piece of information in event 3 (separate from the updated agent ID). Similarly, the original queue ID from event 1 may be included as a new piece of information in event 3.
4) Event 4 ‘Ended’—event 4 contains the call ID. Event 4 may be enriched by including the original agent ID, original queue ID, original customer ID, updated agent ID and updated queue ID. After enrichment, event 4 comprises six pieces of information rather than the initial one piece of information.

Enriching events using information from previous events temporarily stored in cache memory is particularly advantageous when events are ‘dirty’ (e.g., events are incomplete or missing data), for example in legacy systems where the requirement to produce analytics on their performance was not envisaged and the information supplied in the form of events (or other forms of data transfer including APIs and log files) is sparse. Alternatively, enrichment may also enable new performance statistics to be computed that were not considered initially. If a piece of currently unused data is included in an event, the event may be stored temporarily in cache memory and used to enrich later events in order to compute a performance statistic. In the example given above, the time a specific customer was on a call can now be measured by adding the customer ID to event 4 and computing the duration between events 2 and 4 in real-time. Event 4 would contain all the necessary data to perform that processing or measurement in substantially real-time, with no post-processing required to generate any performance statistics reliant on that measurement. The same applies to event 3 with respect to the change of queue, which can be captured in real-time.

In some embodiments, step 244 comprises enriching one or more events with information taken from one or more external sources. The functionality described above with respect to enrichment using information from one or more events temporarily stored in cache memory is equally applicable. The only difference is the source of the enriching information. In some embodiments, the method 200 comprises enriching one or more events using information from one or more external (e.g., third party) databases, customer relationship management (CRM) systems, etc.

For example, a customer may enter their email address on an instant messaging chat form. That email address can be used to look up additional information about that customer. The additional information can be used to enrich events as described above. In that example, performance statistics such as the average duration of instant messaging-based conversations for high value, medium value and low value customers may be computed. A value of the customer to the organization may be stored in an external source such as a CRM application.

In some embodiments, the method 200 may not comprise step 244, and the method 200 may proceed directly from step 242 to step 250. Alternatively, the method 200 may not comprise step 242, and the method 200 may proceed directly from step 240 to 244.

In some embodiments, the method 200 comprises generating a sequence of events (also known as a Journey). Caching one or more events (step 242) and optionally enriching one or more events (step 244) may enable a sequence of related events to be generated.

As described above, steps 242 and 244 of the method 200 may enable a plurality of related events to be tracked and correlated (using a correlation identifier), and information from related events to be combined to create an enriched event. That functionality may enable a Journey to be created in step 246.

An example of a Journey is shown below, using the telephone call example described above in relation to step 244. By adding a new piece of information referred to as a Journey identifier to each event, a Journey may be created using the sequence of related events. The related events may be correlated to one another to generate a Journey in substantially real-time (e.g., as subsequent related events are received) by virtue of caching one or more events at step 242. That may also avoid the need to retrieve one or more events from large volumes of stored data after the fact in order to correlate events with one another. That may improve speed and efficiency of the generation of event sequences.

For example, a telephone call to an agent in a contact centre may comprise the following events:
1) Event 1 ‘Ringing’—event 1 contains a call ID, an agent ID, a queue ID, a customer ID and a journey ID. The journey ID is set to ‘Call Ringing’.
2) Event 2 ‘Answered’—event 2 contains the call ID, the agent ID and a new journey ID. The journey ID is set to ‘Agent Answered’. Event 2 is enriched to include the queue ID and customer ID from event 1.
3) Event 3 ‘Transfer’—event 3 contains the call ID, a new agent ID, a new queue ID and a new journey ID. The journey ID is set to ‘Agent Transfer’. Event 3 is enriched to include the customer ID from event 1, but the updated agent ID and updated queue ID are retained. However, the original agent ID from event 1 and event 2 may be included as a new piece of information in event 3 (separate from the updated agent ID). Similarly, the original queue ID from event 1 may be included as a new piece of information in event 3.
4) Event 4 ‘Ended’—event 4 contains the call ID. The journey ID is set to ‘Call Ended’. Event 4 is enriched to include the customer ID from event 1, and the updated agent ID, updated queue ID, original agent ID and original queue ID from event 3. After enrichment, event 4 comprises six pieces of information rather than initial one piece of information.

From the example above, the following Journey or sequence of events can be created from the Journey identifiers of the respective events: Call Ringing; Agent Answered, Agent Transfer, Call Ended. It will be appreciated that the Journey identifier for each event may relate to, be or comprise a nature of (or a definition of) the event itself. For the example shown above, a Journey identifier for Event 1 ‘Ringing’ is ‘Call Ringing’ etc.

In addition, that functionality can be used to both create a historic Journey and also give a real-time perspective of the current state of a Journey. For example, a current analysis of all answered calls in a contact center may be performed and compared. An example of that would be to compare a number of Journeys comprising ‘Call Ringing; Agent Answered’ to a number of Journeys comprising ‘Call Ringing; Queued’ to provide an indication of all calls that were ringing that were directed to a queue rather than being answered by an agent.

Step 246 may further comprise generating a Journey Measure based on an outcome of the Journey. For example, Journeys may be created through multiple communication channels in a contact center. A first customer may have the following interactions with a contact center of a business:

Customer 1: Customer Email; Agent Email; Sales Voice Call. An outcome of that customer Journey (also known as a Journey Measure) may be ‘No Sale’ and/or ‘Visit Declined’.

A second customer may have the following interactions with a contact center of a business:

Customer 2: Customer Email; Sales Voice Call; Onsite Visit. An outcome of that Journey (also known as a Journey Measure) may be ‘Sale’.

By generating one or more Journeys and generating a Journey Measure for each Journey, it may be seen that some Journeys lead to a particular outcome. In the example shown above, the Journey for Customer 2 in which a Customer Email is followed up by a Sales Voice Call rather than an Agent Email results in a sale (where ‘Sale’ is the Journey Measure for that Journey). In contrast, the Journey for Customer 1 in which a Customer Email is followed up by an Agent Email first (prior to a Sales Voice Call) does not result in a sale (and so ‘No Sale’ is the Journey Measure for that Journey).

Over a large enough sample of Journeys and Journey Measures, patterns may appear which may allow practical insights to be extracted in order to improve performance.

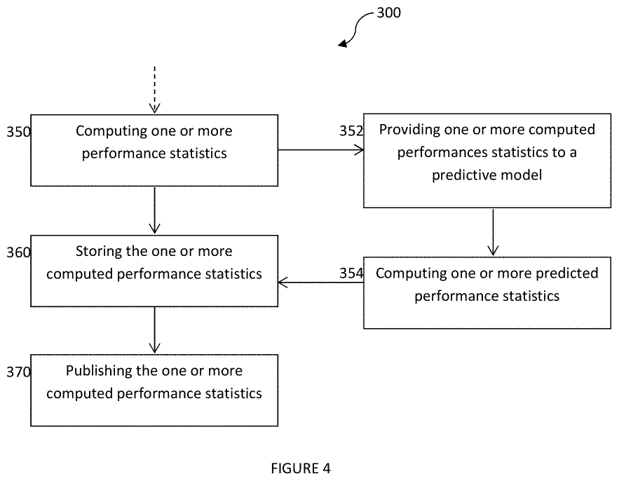

FIG. 4 shows another embodiment of a method 300 for performing data analytics on a data set. The method 300 comprises similar steps to methods 100, 200 described above, with corresponding steps indicated by like reference numerals.

Step 350 of the method 300 comprises computing one or more performance statistics as describe above with respect to the methods 100, 200. Preceding steps of the method 300 correspond to those describe above with respect to the methods 100, 200 and are indicated by the dashed arrow in FIG. 4.

In addition to real-time data analytics and historical data analytics, the method 300 comprises computing predictive data analytics. In the embodiment shown, step 352 of the method 300 comprises providing one or more performance statistics computed at step 350 to a predictive model. The performance statistics may be made available in and retrieved from a storage system (step 160, 260). Step 354 of the method 300 comprises computing one or more predicted performance statistics using the predictive model.

Step 360 of the method 300 comprises storing the one or more predicted performance statistics together with the one or more computed performance statistics. In the embodiment shown, the method 300 comprises storing the one or more performance statistics computed using an interval window in a database system for easy retrieval. Preferably the method 300 comprises storing the predicted and computed performance statistics within the same application or system used to compute the performance statistics. That may allow the information to be stored in a single location for seamless navigation between real-time data analytics, historical data analytics and predictive data analytics.

In some embodiments, the predictive model comprises an artificial intelligence or machine learning model. The machine learning model may be an external or third-party model (e.g., external to the system or application used to compute the real-time and historical performance statistics). In the embodiment shown, the method 300 comprises providing real-time performance statistics computed using an instantaneous window to the machine learning model. Based on the real-time performance statistics, the machine learning model computes a prediction of the performance statistics for a specified point of time or period of time in the future. The periods of time in the future for the predicted performance statistics may substantially correspond to or mirror interval windows used to compute the historical performance statistics. The predicted performance statistics output by the machine learning model are then stored as described above.

The method 300 may also comprise providing historical performance statistics computed at step 350 as training data to train the machine learning model. The real-time data analytics and historical data analytics computed at step 350 are directly comparable and may be contained within the same system or application. Providing directly comparable training and actual data which is computed using a unified approach (e.g., using the same application), from a single location (e.g., a single application) as described above for the methods 100, 200, to the machine learning model, may enable training and operation of the machine learning model to be streamlined for improved speed and efficiency. As described above, conventional systems require real-time data analytics and historical data analytics to be computed using separate applications. Training a machine learning model on historical data analytics computed using one application and operating a machine learning model on real-time data analytics computed using a separate application decreases efficiency and adds complexity to computing predictive analytics.

It will also be appreciated that Journeys and Journey Measures generated at step 246 may be provided to a predictive model substantially as described above for performance statistics computed at step 350. Journeys and Journey Measures generated using the method 200 may form ideal data for a predictive model to predict an optimal path for a desired outcome based on the current event in a Journey.

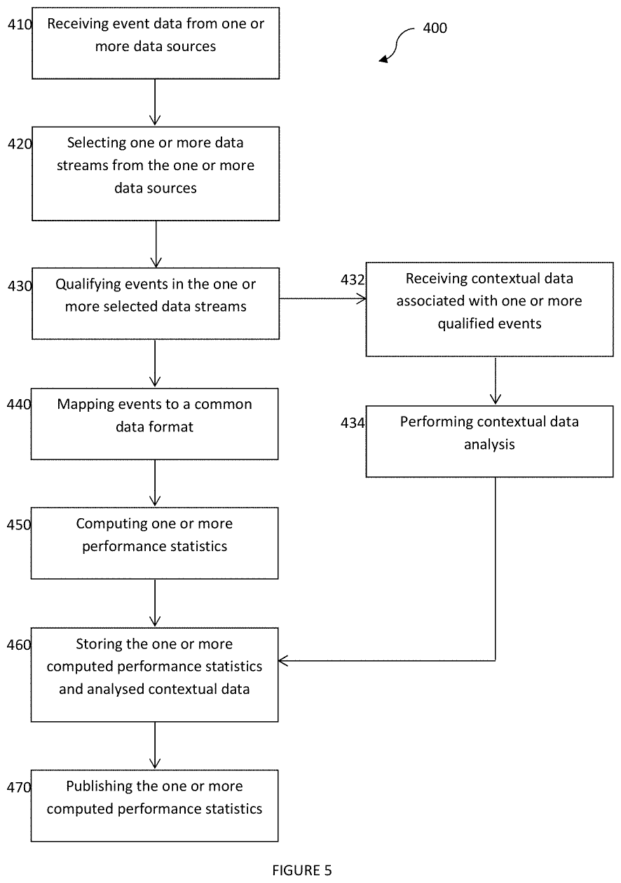

FIG. 5 shows another embodiment of a method 400 for performing data analytics on a data set. The method 400 comprises similar steps to methods 100, 200, 300 described above, with corresponding steps indicated by like reference numerals.

The method 400 comprises performing contextual data analysis on contextual data associated with one or more events used to compute one or more real-time and historical performance statistics. In the embodiment shown, step 432 of the method 400 comprises receiving contextual data associated with one or more qualified events (step 430). Step 434 of the method comprises performing contextual data analysis on that contextual data. In some embodiments, the method 400 comprises performing contextual data analysis over an instantaneous window and/or one or more interval windows to provide real-time analysis, and performing contextual data analysis over an interval window as described above to provide historical contextual data analytics. In an embodiment, the method 400 comprises time-stamping the contextual data analysis in order that the contextual data analysis can be correlated with a performance statistic computed from the one or more events with which the contextual data is associated.

Step 460 of the method 400 comprises storing the analysed contextual data together with the one or more computed performance statistics. In the embodiment shown, the method 400 comprises storing the analysed contextual data in a storage system for easy retrieval. Preferably the method 400 comprises storing the analysed contextual data and computed performance statistics within the same application or system used to compute the performance measures. That may allow the information to be stored in a single location for seamless association of performance statistics with the context of those performance statistics.

In some embodiments, the method 400 comprises providing the contextual data associated with one or more events to a contextual data analysis model. The model may be an external or third-party model (e.g., external to the system or application used to compute the real-time and historical performance statistics). The contextually analysed data output by the model is then stored as described above.

In some embodiments, the contextual data is or comprises speech data recorded during a call, or text data sent during an instant messaging or email conversation. In some embodiments, the contextual data analysis comprises performing sentiment and/or intent analysis on speech data or text data associated with one or more events. For example, sentiment analysis may identify emotion characteristics of the customer and intent analysis may identify what the customer has contacted the contact centre for. A customer may be looking to purchase an item or make a complaint. Intent analysis may reveal which item the customer is looking to purchase, or the reason for the complaint. Sentiment analysis may identify whether the customer is angry with regard a product fault. The analysed contextual data may then be correlated or associated with one or more computed performance statistics. For example, a performance statistic may show the number of calls answered for a given queue (e.g., a sales queue) in the contact centre. Contextual analysis may show, for example, the average sentiment for the calls in that given queue (e.g., a particular product that customers are interested in). Additional performance statistics may include an estimated revenue opportunity waiting in queue with historical analytics available for the average revenue for previous time periods, while predicted analytics provide forecasts for this same data.

The method 400 may enable unified analysis of both structured and unstructured information relating to events, allowing both performance statistics and contextual analysis to be generated, stored and published or displayed using a single application.

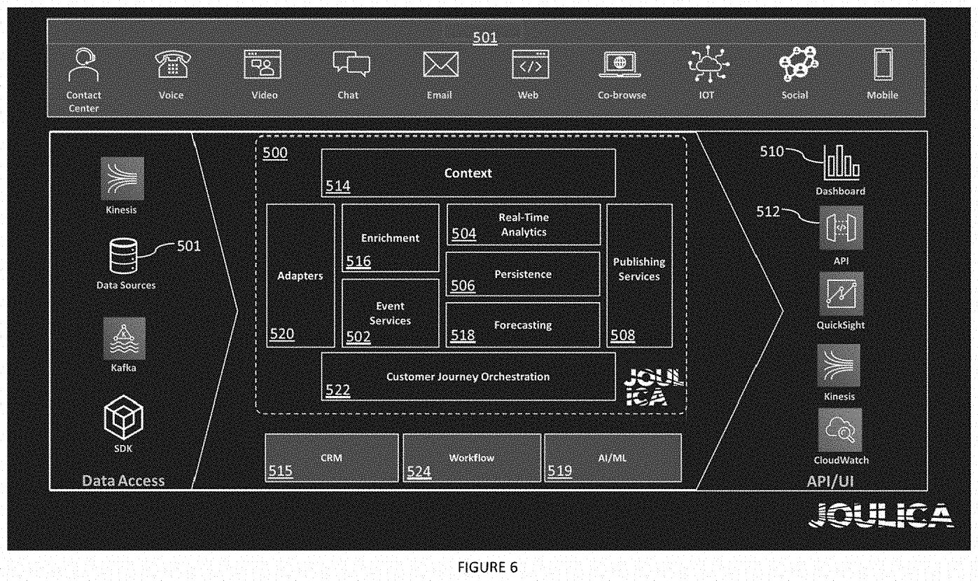

FIG. 6 shows a system 500 for performing data analytics. In the embodiment shown, the system 500 is configured to perform any of methods 100-400 described above. The dotted line shown in FIG. 6 encompasses a majority of the system 500 (discussed further below) and illustrates the relationship of the system 500 to external systems and applications.

In the embodiment shown, the system 500 comprises a module 502 (“Event Services”) configured to receive event data (e.g., raw event data or events) from one or more data sources 501 (step 110). In the embodiment shown, at least some of the data sources 501 are specific to implementation of the system 500 in a contact center, for example voice, video, chat, but it will be appreciated that one or more data sources 501 may comprise any data. For example, the data sources 501 may be relevant to a specific application of the system 500 such as for tracking vehicle fleets etc. Event streaming platforms such as AWS Kinesis and Kafka may be used as sources of data (e.g., sources of events) to be processed by the system 500.

In the embodiment shown, the module 502 contains logic and information defining the processing required to take place in order to compute one or more performance statistics 152A, 152B. The module 502 therefore contains a definition for each of one or more measure processors (e.g., measure processor 151), and a definition of one or more events necessary for computing performance statistics using each measure processor. In some embodiments, the module 502 is further configured to perform one or more of the following: selecting one or more data output channels from one or more of the data sources (step 120); qualifying data from one or more of the data sources (step 130); and mapping data from one or more data sources to a common data format (step 140). In such embodiments, the module 502 is configured to perform steps 120, 130, 140 using pre-defined criteria, for example the one or more events necessary for computing the performance statistics. Alternatively, one or more additional or separate modules of the system 500 may be configured to perform the steps 120, 130, 140 rather than the module 502.

The system 500 also comprises a module 504 (“Real-time Analytics”) configured to compute one or more performance statistics (step 150). In the embodiment shown, the module 504 is configured to compute the performance statistics according to the definitions (e.g., measure processors 151, necessary events etc.) contained within the module 502, and optionally using the qualified and/or mapped data received from the module 502.

The system 500 further comprises a module 506 (“Persistence”) configured to send computed performance statistics to storage (step 160), for example a database service such as AWS Redshift.

The system 500 further comprises a module 508 (“Publishing Services”) configured to publish computed performance statistics. The system 500 also comprises a dashboard module 510 configured to provide a display of the computed performance statistics. The dashboard module 510 is configured to be displayed on a monitor. In the embodiment shown, the module 508 is configured to provide computed performance statistics to the module 510 of the system 500 and/or to external applications such as AWS QuickSight, AWS CloudWatch etc. (which can be used to define dashboards for displaying the computed performance statistics). In the embodiment shown, the system 500 comprises an API 512 which is exposed by the system 500 to enable external applications to access and manage computed performance statistics.

In the embodiment shown, the system 500 acts as a Kafka client, publishing computed and/or predicted performance statistics to Kafka (e.g., as events). That may enable the computed and/or predicted performance statistics to be published to external applications. Third party clients may use Kafka APIs to monitor for performance statistics computed by the system 500. Similar considerations apply with respect to AWS Kinesis. Additionally or alternatively, the system 500 may be configured to interact with event service applications other than Kafka and AWS Kinesis, although it will be appreciated that the system 500 would operate or function in a similar manner as described above.

In the embodiment shown, the system 500 also comprises a module 514 (“Context”) configured to act as or provide a cache memory for temporary storage of events and/or data retrieved from external systems (step 242), such as CRM software 515. The system 500 further comprises a module 516 (“Enrichment”) configured to enrich one or more events, for example with information taken from one or more events or other information stored in the module 514 (step 244). Alternatively, the system 500 may not comprise the modules 514, 516.

In the embodiment shown, the system 500 comprises a module 518 (“Forecasting”) configured to integrate the system 500 with predictive models, for example external Al services 519 such as AWS SageMaker. The module 518 is configured to send computed performance statistics to one or more predictive models and receive predicted performance statistics from the predictive models. In such embodiments, the module 508 is further configured to publish predicted performance statistics, together with computed performance statistics. Alternatively, the system 500 may not comprise module 518.

In the embodiment shown, the system 500 comprises adapters 520 configured to integrate the system 500 to external applications.

In the embodiment shown, the system 500 further comprises a module 522 (“Customer Journey Orchestration”) configured to generate a sequence of events or a Journey, and optionally configured to generate a Journey Measure based on an outcome of the Journey (step 246). Alternatively, the system 500 may not comprise module 522.

In the embodiment shown, the system 500 comprises a module 524 (“Workflow”) configured to utilise the computed performance statistics to determine and/or instruct operational adjustments. For example, in a contact center application, the module 520 may be configured to utilise the computed performance statistics to automatically adjust (e.g., automatically) how customer interactions are handled. For example, if the computed performance statistics exceed a threshold (e.g., a predetermined threshold), the module 524 may throttle or adjust the number of customers queueing.

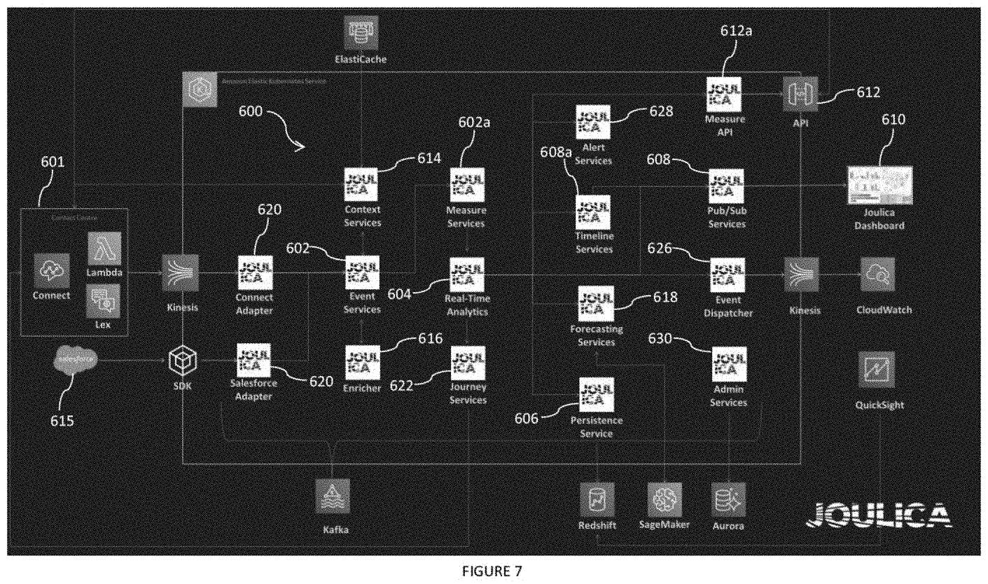

FIG. 7 shows an embodiment of a system 600 configured for performing data analytics for a contact center. In the embodiment shown, the system 600 is configured to perform any of methods 100-400 described above. The system 600 comprises similar components and/or modules to the system 500 described above, each configured to perform the same or a similar function as described above. Corresponding components are indicated by like reference numerals.

In the embodiment shown, the system 500 is implemented in a cloud environment. In the embodiment shown, the system 500 is deployed and managed using a container orchestration service such as Kubernetes (e.g., Amazon Elastic Kubernetes Service).

The system 600 is configured to receive data from a plurality of contact center data sources 601. In the embodiment shown, the contact center comprises a telephone service (AWS Connect), a chat bot service (AWS Lex) and a platform for writing events-based applications (AWS Lambda).

In the embodiment shown, the module 602 (“Events Services”) further comprises a sub-module 602a (“Measure Services”) which is a low-level component of the module 602. In the embodiment shown, the module 602 is configured to receive event data (e.g., raw event data or events) from one or more data sources 601. In the embodiment shown, the module 602 is further configured to map data or events from the one or more data sources 601 to a common data format and refine the events. Refinement of the events may enable efficient processing. The refinement may be as simple as removing data from the events that is not needed to compute performance statistics, for example by mapping the data or events to the common data format. In the embodiment shown, the module 602 is also configured to qualify data or events from the one or more data sources 601. That may ensure that only measurable data or events is passed to the sub-module 602a. In the embodiment shown, the sub-module 602a is configured to receive events from the module 602. The sub-module 602a is further configured to produce a measure specification for each performance statistic of interest, based on the relevant measure processor definition and one or more events received from the module 602. Alternatively, the system 600 may not comprise the module 602a.

In the embodiment shown, the module 604 is configured to compute one or more performance statistics by performing computations specified in the measure specifications produced by the sub-module 602a.

In the embodiment shown, the module 608 (“Pub/Sub Services”) further comprises a sub-module 608a (“Timeline Services”). The sub-module 608a is or comprises a low-level component of the module 608, configured to optimize access to computed performance statistics for time series analysis. Alternatively, the system 600 may not comprise the module 608a.

In the embodiment shown, the system 600 comprises a module 612a (“Measure API”). The module 612a is configured to expose the API 612 to enable external applications to access and manage computed performance statistics.

In the embodiment shown, the module 614 is implemented using AWS Elasticache as an in-memory cache service, although it will be appreciated any suitable cache memory may be used. Alternatively, the system 600 may not comprise the module 614.

In the embodiment shown, the system 600 comprises adapters 620 configured to integrate the system 600 to the external applications 615 (Salesforce CRM software, AWS Connect). It will be appreciated that different adapters 620 may be used depending on the external applications 615 with which the system 600 is to be integrated.

The system 600 also comprises a module 622 (“Journey Services”) configured to generate a sequence of events or a Journey, and optionally configured to generate a Journey Measure based on an outcome of the Journey (step 246). Alternatively, the system 500 may not comprise module 522. Alternatively, the system 600 may not comprise the module 622.

In the embodiment shown, the system 600 comprises a module 626 (“Event Dispatcher”) configured to dispatch computed performance statistics as events to one or more external applications, such as AWS Kinesis. Alternatively, the system 600 may not comprise the module 626.

In the embodiment shown, the system 600 comprises a module 628 (“Alert Services”) configured to generate an alert in response to a computed or predicted performance statistic not meeting a predetermined threshold. For example, a computed performance statistic may exceed a predetermined threshold (e.g., number of calls exceeding a predetermined duration) or falls below a predetermined threshold. The predetermined threshold may be configurable or reconfigurable by a user of the system 600. Alternatively, the system 600 may not comprise the module 628.

In the embodiment shown, the system 600 comprises a module 630 (“Admin Services”) configured to perform general administration of the system 600. In the embodiment shown, the module 630 is configured to communicate with a database service such as AWS Aurora. Alternatively, the system 600 may not comprise the module 630.

In the embodiment shown, the system 600 comprises one or more Software Development Kits or SDKs to enable the adaptors 620 to integrate with the external applications 615. For example, a Salesforce Adaptor 620 may use a Salesforce SDK to integrate with Salesforce CRM software. However, the AWS Connect adaptor 620 may use AWS Kinesis to integrate with AWS Connect.

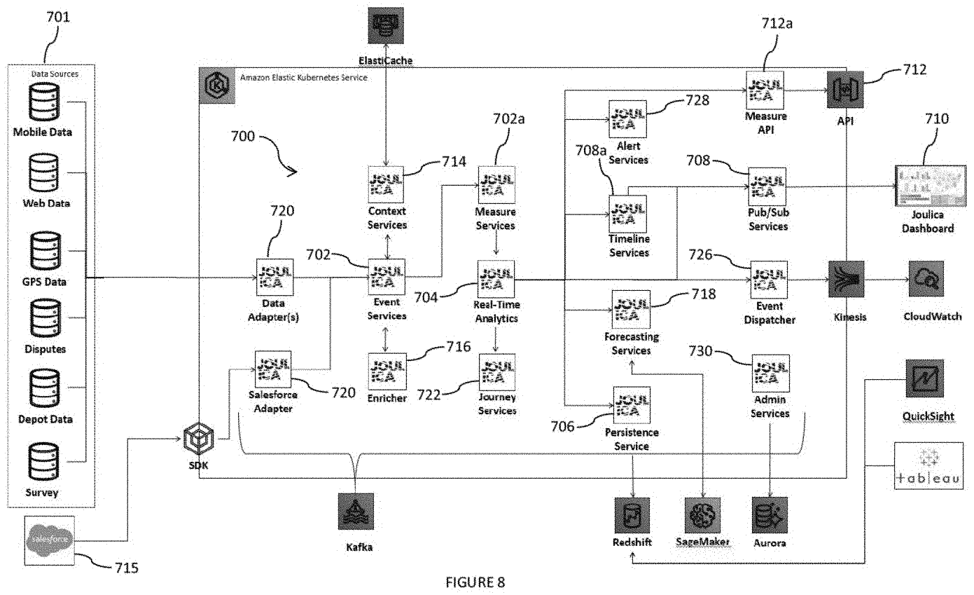

FIG. 8 shows an embodiment of a system 700 configured for performing data analytics for vehicle fleet data. In the embodiment shown, the system 700 is configured to perform any of methods 100-400 described above. The system 700 comprises similar components and/or modules to the systems 500, 600 described above, each configured to perform the same or a similar function as described above. Corresponding components are indicated by like reference numerals.

The system 700 is substantially similar to the system 600 described above. Differences include the data sources 701 (which are specific to vehicle fleet data, for example GPS Data, Depot Data etc.), and the adapters 720 which, as described above, are specific to the external applications with which the system 700 is to be integrated.

From reading the present disclosure, other variations and modifications will be apparent to the skilled person. Such variations and modifications may involve equivalent and other features which are already known in the art of data analytics, and which may be used instead of, or in addition to, features already described herein.

For the sake of completeness, it is also stated that the term “comprising” does not exclude other elements or steps, the term “a” or “an” does not exclude a plurality, a single processor or other unit may fulfil the functions of several means recited in the claims and any reference signs in the claims shall not be construed as limiting the scope of the claims.

1. A computer-implemented method of providing unified data analytics, the method comprising:
receiving data from one or more data sources:
processing the data;
computing one or more statistics by aggregating an output of the processing:
i) at an instantaneous point in time; and
ii) over a predetermined duration of time.

2. The method of claim 1, wherein the data is or comprises event data.

3. The method of claim 1, wherein the data is or comprises a stream of event data.

4. The method of claim 3, wherein:
receiving the data comprises receiving a stream of substantially real-time events; and
processing the data comprises processing in substantially real-time using one or more events from the stream.

5. The method of claim 2, further comprising:
defining one or more processing categories;
defining, for each of one or more processing categories, a processing logic and one or more events necessary for that processing category; and
processing the necessary events for each the of one or more processing categories.

6. The method of claim 5, further comprising:
assigning each statistic to a processing category; and
defining one or more pieces of information from the necessary events for the processing category for processing the events for each statistic.

7. The method of claim 2, further comprising temporarily storing at least a subset of information from each of one or more events in a cache memory.

8. The method of claim 7, further comprising enriching subsequent events using information from one or more events temporarily stored in the cache memory.

9. The method of claim 7, further comprising processing one or more events retrieved from the cache memory in combination with one or more subsequent events.

10. The method of claim 1, further comprising:
time-stamping the one or more computed statistics; and
storing the time-stamped statistics computed over a predetermined duration of time.

11. The method of claim 1, further comprising:
providing the one or more computed statistics to a predictive model; and
generating one or more predicted statistics based on the one or more computed statistics.

12. The method of claim 11, wherein the predictive model is a machine learning model, and further comprising:
providing the one or more statistics computed over a predetermined duration of time to the machine learning model as training data; and
providing the one or more statistics computed at an instantaneous point in time to the machine learning model as real data to generate the one or more predicted statistics.

13. The method of claim 2, further comprising:
receiving contextual data associated with one or more events;
performing contextual data analysis on the contextual data; and
correlating analysed contextual data with one or more computed statistics.

14. The method of claim 13, further comprising:
performing sentiment and/or intent analysis on speech data and/or text data associated with one or more events.

15. The method of claim 1, wherein the predetermined duration of time comprises a static time window or a moving time window.

16. The method of claim 1, further comprising selecting one or more data output channels from one or more of the data sources, optionally based on one or more predefined criteria, or, further comprising qualifying data from the one or more data sources, optionally based on one or more predefined criteria.

17. The method of claim 16, wherein the data is or comprises event data, and the method further comprises:
defining one or more processing categories;
defining, for each of one or more processing categories, a processing logic and one or more events necessary for that processing category; and
processing the necessary events for each of the one or more processing categories, and wherein the one or more predefined criteria comprise the one or more events necessary for each of the one or more processing categories.

18. The method of claim 1, further comprising mapping or transforming data from one or more data sources to a common data format.

19. A system for providing unified data analytics, the system comprising:
a module configured to receive data from one or more data sources;
a module configured to process the data; and
a module configured to compute one or more statistics by aggregating an output of the processing:
i) at an instantaneous point in time; and
ii) over a predetermined duration of time.
